(19) United States
(12) Patent Application Publication
(10) Pub. No.: US 2025/0210226 A1
(43) Pub. Date: Jun. 26, 2025

(54) INSULATED ELECTRIC WIRE, AND METHOD FOR MANUFACTURING INSULATED ELECTRIC WIRE

(71) Applicant: Yazaki Corporation, Tokyo (JP)

(72) Inventors: Moeko Aoki, Shizuoka (JP); Hiroki Kondo, Shizuoka (JP)

(21) Appl. No.: 19/075,198

(22) Filed: Mar. 10, 2025

Related U.S. Application Data
(63) Continuation of application No. PCT/JP2024/000188, filed on Jan. 9, 2024.

(30) Foreign Application Priority Data
Jan. 18, 2023 (JP) 2023-005646

(51) Int. Cl. H01B 7/02; H01B 13/08

(52) U.S. Cl. CPC H01B 7/0241; H01B 13/0883

(57) ABSTRACT

An insulated electric wire is formed by spirally winding an insulating tape laminating an insulating layer and an adhesive layer onto a conductor such that the adhesive layer is disposed onto the conductor, in which when a conductor diameter is x mm, the insulating tape has an overlap length y of y≥1.5099ln(x)−0.4959 mm, a width z of z≤−0.3774x+24.547 mm, and an adhesive force c of c≥3.2 N/19 mm with respect to a back surface of the insulating tape which is opposite to the adhesive layer.

### CROSS-REFERENCE TO RELATED APPLICATIONS

The present application is a continuation application of PCT/JP2024/000188 that claims priority to Japanese Patent Application No. 2023-005646 filed on Jan. 18, 2023, the entire content of which is incorporated herein by reference.

### TECHNICAL FIELD

The present disclosure relates to an insulated electric wire and a method for manufacturing an insulated electric wire.

### BACKGROUND ART

In the related art, there has been proposed an insulated electric wire in which a covering portion is formed by spirally winding an insulating tape directly around a conductor (see JPH10-97815A and JPH06-73818U).

Here, in the insulated electric wire described in JPH10-97815A and JPH06-73818U, since the insulating tape is spirally wound around the conductor, when the insulated electric wire is bent, there may be a gap between the wound insulating tape on an outer side of a bent portion, exposing the conductor.

### SUMMARY OF INVENTION

The present disclosure provides an insulated electric wire and a method for manufacturing an insulated electric wire which are capable of reducing a possibility of conductor exposure during bending.

According to an illustrative aspect of the present disclosure, an insulated electric wire is formed by spirally winding an insulating tape laminating an insulating layer and an adhesive layer onto a conductor such that the adhesive layer is disposed onto the conductor, in which when a conductor diameter is x mm, the insulating tape has an overlap length y of y≥1.5099 ln(x)−0.4959 mm, a width z of z≤−0.3774x+24.547 mm, and an adhesive force c of c≥3.2 N/19 mm with respect to a back surface of the insulating tape which is opposite to the adhesive layer.

According to another illustrative aspect of the present disclosure, a method for manufacturing an insulated electric wire includes: a first step of preparing a conductor having a conductor diameter of x mm; a second step of preparing an insulating tape laminating an insulating layer and an adhesive layer, the insulating tape having a width z of z≤−0.3774x+24.547 mm and an adhesive force c of c≥3.2 N/19 mm with respect to a back surface of the insulating tape which is opposite to the adhesive layer; and a third step of spirally winding the insulating tape prepared in the second step such that the adhesive layer is disposed onto the conductor prepared in the first step and an overlap length y is y≥1.5099 ln(x)−0.4959 mm.

According to the present disclosure, it is possible to reduce a possibility of conductor exposure during bending.

### BRIEF DESCRIPTION OF DRAWINGS

FIG. 1 is a perspective view showing an insulated electric wire according to an embodiment of the present disclosure;

FIG. 2 is an enlarged cross-sectional view of a portion of a configuration shown in FIG. 1;

FIG. 3 is a process diagram showing a method for manufacturing an insulated electric wire according to the present embodiment;

FIG. 4 is a table showing Examples 1 to 12 and Comparative Examples 1 to 4;

FIG. 5 is a table showing threshold values of an overlap length y based on experiment results in Examples 1 to 12 and Comparative Examples 1 to 4;

FIG. 6 is a graph showing details of the experiment results and the threshold values in Examples 1 to 12 and Comparative Examples 1 to 4;

FIG. 7 is a table showing Examples 13 to 21 and Comparative Examples 5 to 7;

FIG. 8 is a table showing threshold values of a width z pf an insulating tape based on experiment results in Examples 13 to 21 and Comparative Examples 5 to 7;

FIG. 9 is a graph showing details of the experiment results and the threshold values in Examples 13 to 21 and Comparative Examples 5 to 7;

FIG. 10 is a table showing threshold values of the width z of the insulating tape at which winding is difficult;

FIG. 11 is a table showing Examples 22 to 27 and Comparative Examples 8 to 13;

FIG. 12 is a table showing threshold values of an adhesive force c based on experiment results in Examples 22 to 27 and Comparative Examples 8 to 13; and

FIG. 13 is a graph showing details of the experiment results and the threshold values in Examples 22 to 27 and Comparative Examples 8 to 13.

### DESCRIPTION OF EMBODIMENTS

Hereinafter, the present disclosure will be described with reference to a preferred embodiment. The present disclosure is not limited to the embodiment to be described below, and the embodiment can be appropriately changed without departing from the gist of the present disclosure. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

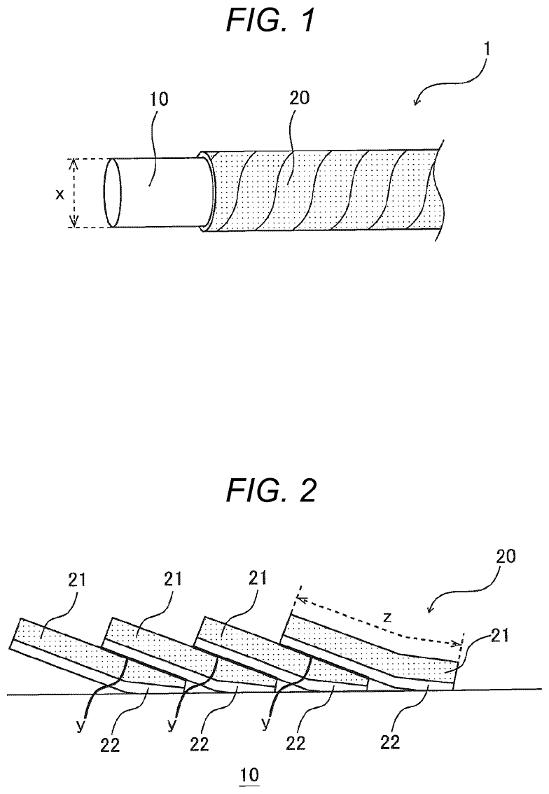

FIG. 1 is a perspective view showing an insulated electric wire 1 according to an embodiment of the present disclosure. FIG. 2 is an enlarged cross-sectional view of a portion of a configuration shown in FIG. 1. As shown in FIG. 1, the insulated electric wire 1 according to the present embodiment includes a conductor 10 and an insulating tape 20.

The conductor 10 is made of a conductive metal such as copper, aluminum, or an alloy thereof, and has a circular or substantially circular cross-sectional shape. As shown in FIG. 2, the insulating tape 20 is formed by laminating an insulating layer 21 and an adhesive layer 22. The insulating tape 20 is spirally wound directly on the conductor 10 such that the adhesive layer 22 is disposed onto the conductor 10. When wound around the conductor 10, the insulating tape 20 is wound to have an overlap length y where the insulating tapes 20 overlap each other. Accordingly, the insulated electric wire 1 is formed by winding the insulating tape 20 directly on the conductor 10 without exposing the metal constituting the conductor 10. In the present embodiment, a back surface opposite to the adhesive layer 22 is the insulating layer 21, but the present embodiment is not limited to this, and another layer may be formed on the insulating layer 21, and the another layer may be located on the back surface. In addition, another layer may be provided between the insulating layer 21 and the adhesive layer 22.

Here, it is necessary that the conductor 10 in such an insulated electric wire 1 is not exposed even during bending (during self-radial bending). Therefore, in the insulated electric wire 1 according to the present embodiment, the insulating tape 20 has an adhesive force c of 3.2 N/19 mm or more with respect to the back surface of the insulating tape 20 (the insulating layer 21 in the example shown in FIG. 2). Therefore, the insulating tape 20 is unlikely to shift relatively during bending, and the conductor 10 is unlikely to be exposed.

In addition, in the insulated electric wire 1 according to the present embodiment, when a diameter (conductor diameter) of the conductor 10 is x mm, the insulating tape 20 has an overlap length y of 1.5099 ln(x)−0.4959 mm or more. In this way, since the overlap length y is 1.5099 ln(x)−0.4959 mm or more, even when the insulating tape 20 slightly shifts at an overlapping portion of the insulating tape 20 during bending, the overlap length y is ensured, and the conductor exposure is prevented.

Further, in the insulated electric wire 1 according to the present embodiment, the insulating tape 20 has a width z of −0.3774x+24.547 mm or less. Here, when the width z is large, a large force is applied to one point on the overlap length y during bending, and the insulating tape 20 is likely to shift. However, since the insulating tape 20 has a width z of −0.3774x+24.547 mm or less, such a situation can be prevented.

In the insulated electric wire 1 according to the present embodiment, the width z of the insulating tape 20 is preferably less than 3.2978x+2.282 mm. When the width z is 3.2978x+2.282 mm or more and is too large relative to the conductor diameter x, the insulating tape 20 wrinkles when spirally wound or the overlap length y gradually increases, making it difficult to wind the insulating tape 20 in a spiral shape.

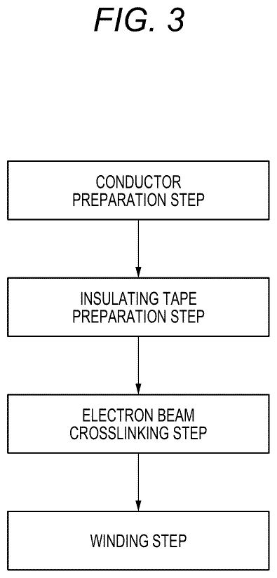

Next, a method for manufacturing the insulated electric wire 1 according to the present embodiment will be described. FIG. 3 is a process diagram showing the method for manufacturing the insulated electric wire 1 according to the present embodiment. First, as shown in FIG. 3, a conductor preparation step (first step) is carried out. In this step, the conductor 10 having a conductor diameter of x mm is prepared.

Next, an insulating tape preparation step (second step) is carried out. In this step, the prepared insulating tape 20 includes the insulating layer 21 and the adhesive layer 22 laminated thereon, and has a width z of −0.3774x+24.547 mm or less. Further, in this step, the insulating tape 20 is prepared to have an adhesive force c of 3.2 N/19 mm or more with respect to the back surface of the insulating tape 20.

Next, an electron beam crosslinking step (fourth step) is carried out. In this step, the insulating tape 20 prepared in the insulating tape preparation step is subjected to electron beam crosslinking to increase a heat resistance temperature.

Thereafter, a winding step (third step) is carried out. In this step, the insulating tape 20 prepared in the insulating tape preparation step and subjected to the electron beam crosslinking in the electron beam crosslinking step is spirally wound around the conductor 10 prepared in the conductor preparation step such that the overlap length y is y≥1.5099 ln(x)−0.4959 mm. At this time, the insulating tape 20 is wound such that the adhesive layer 22 of the insulating tape 20 is disposed onto the conductor 10.

With the above, the insulated electric wire 1 according to the present embodiment is obtained. As described above, the electron beam crosslinking step is carried out prior to the winding step. When the electron beam crosslinking is performed after winding, one side of the insulating tape 20 is irradiated with an electron beam, and it is difficult to irradiate the other side across the conductor 10 with the electron beam, making it difficult to increase the heat resistance temperature on the other side. However, when the insulating tape 20 is irradiated before winding, the electron beam irradiation is not hindered by the conductor 10, and it is easier to irradiate the entire insulating tape 20 with the electron beam.

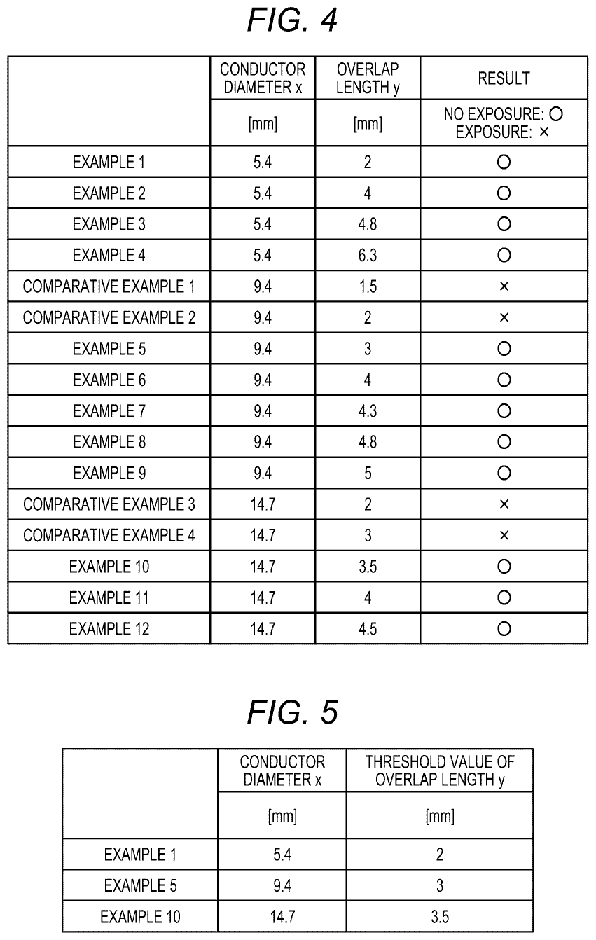

Next, Examples and Comparative Examples will be described. FIG. 4 is a table showing Examples 1 to 12 and Comparative Examples 1 to 4. In Examples 1 to 12 and Comparative Examples 1 to 4 shown in FIG. 4, insulating tapes (vinyl chloride tape) each having an adhesive force c of 3.2 N/19 mm and a width z of 19 mm were wound around a conductor at various overlap lengths y, to thereby form insulated electric wires.

More specifically, in Examples 1 to 4, the insulating tape was wound around a conductor having a conductor diameter x of 5.4 mm (10 square millimeter), to form the insulated electric wires. The overlap length y was 2 mm in Example 1, 4 mm in Example 2, 4.8 mm in Example 3, and 6.3 mm in Example 4.

In addition, in Comparative Examples 1 and 2 and Examples 5 to 9, the insulating tape was wound around a conductor having a conductor diameter x of 9.4 mm (40 square millimeter), to form the insulated electric wires. The overlap length y was 1.5 mm in Comparative Example 1, 2 mm in Comparative Example 2, 3 mm in Example 5, and 4 mm in Example 6. In addition, the overlap length y was 4.3 mm in Example 7, 4.8 mm in Example 8, and 5 mm in Example 9.

In addition, in Comparative Examples 3 and 4 and Examples 10 to 12, the insulating tape was wound around a conductor having a conductor diameter x of 14.7 mm (95 square millimeter), to form the insulated electric wires. The overlap length y was 2 mm in Comparative Example 3, 3 mm in Comparative Example 4, 3.5 mm in Example 10, 4 mm in Example 11, and 4.5 mm in Example 12.

The insulated electric wires in Examples 1 to 12 and Comparative Examples 1 to 4 formed as described above were held in a self-radially bent state for several seconds, and measurement was made as to whether the conductor was exposed. As a result, no exposure occurs in Examples 1 to 12, while exposure occurs in Comparative Examples 1 to 4.

FIG. 5 is a table showing threshold values of the overlap length y based on experiment results in Examples 1 to 12 and Comparative Examples 1 to 4. As shown in FIG. 4 and FIG. 5, in the case of a conductor diameter x of 5.4 mm, when the overlap length y is 2 mm or more, which is equal to or greater than that in Example 1, the conductor exposure is prevented. In addition, in the case of a conductor diameter x of 9.4 mm, when the overlap length y is 3 mm or more, which is equal to or greater than that in Example 5, the conductor exposure is prevented. In addition, in the case of a conductor diameter x of 14.7 mm, when the overlap length y is 3.5 mm or more, which is equal to or greater than that in Example 10, the conductor exposure is prevented.

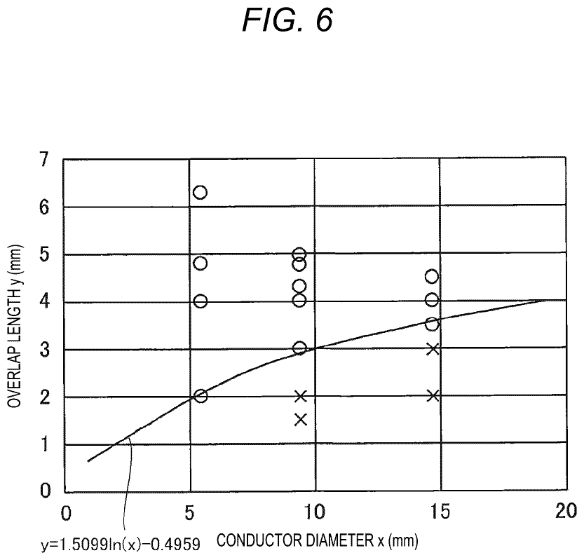

FIG. 6 is a graph showing details of the experiment results and the threshold values in Examples 1 to 12 and Comparative Examples 1 to 4. As shown in FIG. 6, when the conductor diameter x is 5.4 mm, the overlap length y needs to be 2 mm or more, when the conductor diameter x is 9.4 mm, the overlap length y needs to be 3 mm or more, and when the conductor diameter x is 14.7 mm, the overlap length y needs to be 3.5 mm or more. Therefore, as seen from a result of finding an approximate formula using logarithmic approximation based on these, in the case of winding an insulating tape having an adhesive force c of 3.2 N/19 mm and a width z of 19 mm, when the overlap length y is 1.5099 ln(x)−0.4959 mm or more, the conductor exposure during self-radial bending is prevented.

It is clear that the greater the adhesive force c, the more the conductor exposure is prevented. Therefore, when the overlap length y is 1.5099 ln(x)−0.4959 mm or more, the conductor exposure during self-radial bending can be prevented even in an insulating tape having an adhesive force c of more than 3.2 N/19 mm. As described above, the width z of the insulating tape is preferably small. Therefore, when the overlap length y is 1.5099 ln(x)−0.4959 mm or more, the conductor exposure during self-radial bending can be prevented even in an insulating tape having a width z of less than 19 mm.

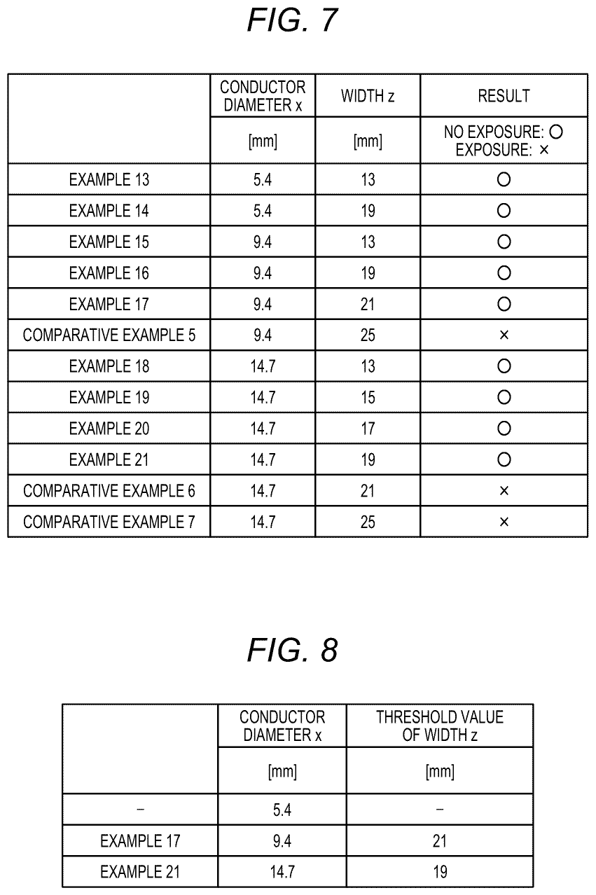

FIG. 7 is a table showing Examples 13 to 21 and Comparative Examples 5 to 7. In Examples 13 to 21 and Comparative Examples 5 to 7 shown in FIG. 7, insulating tapes (vinyl chloride tape) each having an adhesive force c of 3.2 N/19 mm and respectively having various widths z were wound around a conductor at the overlap lengths y as the threshold values shown in FIG. 5, to thereby form insulated electric wires.

More specifically, in Examples 13 and 14, the insulating tape was wound around a conductor having a conductor diameter x of 5.4 mm at an overlap length y of 2 mm, to form the insulated electric wires. The width z of the insulating tape was 13 mm in Example 13 and 19 mm in Example 14.

In addition, in Examples 15 to 17 and Comparative Example 5, the insulating tape was wound around a conductor having a conductor diameter x of 9.4 mm at an overlap length y of 3 mm, to form the insulated electric wires. The width z of the insulating tape was 13 mm in Example 15, 19 mm in Example 16, 21 mm in Example 17, and 25 mm in Comparative Example 5.

In addition, in Examples 18 to 21 and Comparative Examples 6 and 7, the insulating tape was wound around a conductor having a conductor diameter x of 14.7 mm at an overlap length y of 3.5 mm, to form the insulated electric wires. The width z of the insulating tape was 13 mm in Example 18, 15 mm in Example 19, 17 mm in Example 20, 19 mm in Example 21, 21 mm in Comparative Example 6, and 25 mm in Comparative Example 7.

The insulated electric wires in Examples 13 to 21 and Comparative Examples 5 to 7 formed as described above were held in a self-radially bent state for several seconds, and measurement was made as to whether the conductor was exposed. As a result, no exposure occurs in Examples 13 to 21, while exposure occurs in Comparative Examples 5 to 7.

FIG. 8 is a table showing threshold values of the width z pf the insulating tape based on experiment results in Examples 13 to 21 and Comparative Examples 5 to 7. As shown in FIG. 7 and FIG. 8, when the conductor diameter x is 5.4 mm, as shown in Examples 13 and 14, the conductor is not exposed but the threshold value cannot be obtained. On the other hand, in the case of a conductor diameter x of 9.4 mm, when the width z is 21 mm or less, which is equal to or smaller than that in Example 17, the conductor exposure is prevented. In addition, in the case of a conductor diameter x of 14.7 mm, when the width z is 19 mm or less, which is equal to or smaller than that in Example 21, the conductor exposure is prevented.

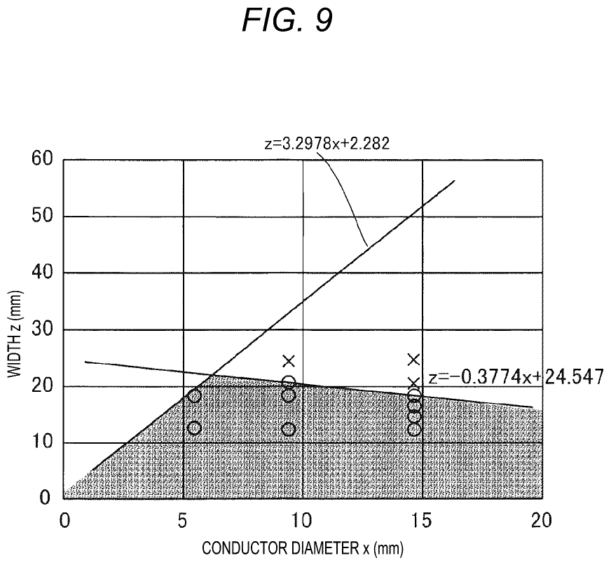

FIG. 9 is a graph showing details of the experiment results and the threshold values in Examples 13 to 21 and Comparative Examples 5 to 7. As shown in FIG. 9, when the conductor diameter x is 9.4 mm, the width z of the insulating tape needs to be 21 mm or less, and when the conductor diameter x is 14.7 mm, the width z of the insulating tape needs to be 19 mm or less. Therefore, as seen from a result of finding an approximate formula using linear approximation based on these, in the case of winding an insulating tape having an adhesive force c of 3.2 N/19 mm at the overlap length y shown in FIG. 5, when the width z of the insulating tape is −0.3774x+24.547 mm or less, the conductor exposure during self-radial bending is prevented.

As shown in FIG. 6, it is clear that the greater the overlap length y, the more the conductor exposure is prevented. Therefore, when the width z of the insulating tape is-0.3774x+24.547 mm or less, the conductor exposure during self-radial bending can be prevented even when the overlap length y is more than the threshold values shown in FIG. 5. In addition, it is clear that the greater the adhesive force c, the more the conductor exposure is prevented. Therefore, when the width z of the insulating tape is −0.3774x+24.547 mm or less, the conductor exposure during self-radial bending can be prevented even in an insulating tape having an adhesive force c of more than 3.2 N/19 mm.

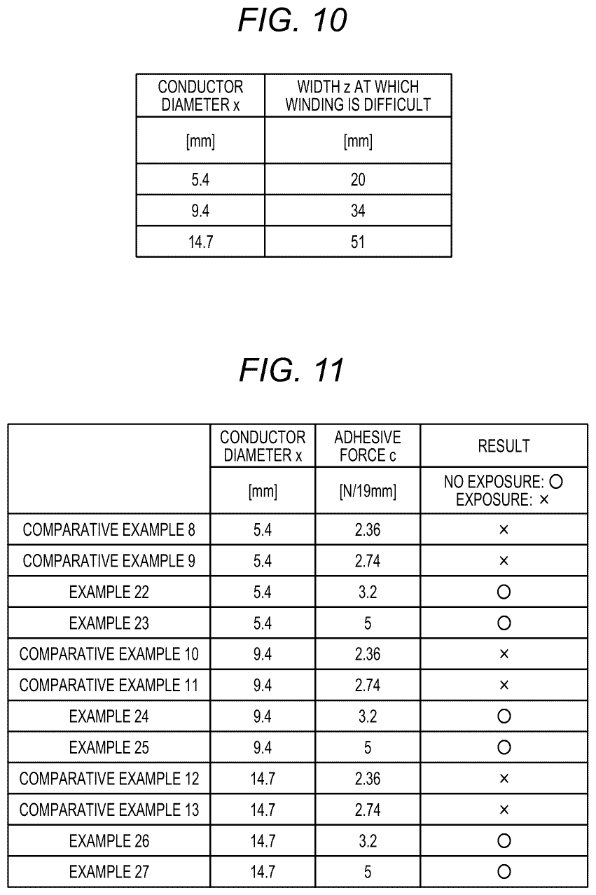

FIG. 10 is a table showing threshold values of the width z of the insulating tape at which winding is difficult. Here, when the width z of the insulating tape is too large, the insulating tape wrinkles when spirally wound or the overlap length y gradually increases, making it difficult to wind the insulating tape in a spiral shape. The width z at which spirally winding is extremely difficult can be calculated according to (circumferential length of conductor)+ (threshold value of overlap length y)+1. Therefore, the width z of the insulating tape is preferably less than 3.2978×+2.282 mm, and as shown in FIG. 10, is 20 mm when the conductor diameter x is 5.4 mm, 34 mm when the conductor diameter x is 9.4 mm, and 51 mm when the conductor diameter x is 14.7 mm. Therefore, the width z of the insulating tape that is free from wrinkles, that can easily maintain the overlap length y, and that can prevent the conductor exposure during self-radial bending is −0.3774x+24.547 mm or less and less than 3.2978x+2.282 mm. That is, it is the shaded region in FIG. 9.

FIG. 11 is a table showing Examples 22 to 27 and Comparative Examples 8 to 13. In Examples 22 to 27 and Comparative Examples 8 to 13 shown in FIG. 11, insulating tapes (vinyl chloride tape) each having a width z of 19 mm and respectively having various adhesive forces c were wound around a conductor at the overlap lengths y as the threshold values shown in FIG. 5, to thereby form insulated electric wires.

More specifically, in Comparative Examples 8 and 9 and Examples 22 and 23, the insulating tape was wound around a conductor having a conductor diameter x of 5.4 mm at an overlap length y of 2 mm, to form the insulated electric wires. The adhesive force c was 2.36 N/19 mm in Comparative Example 8, 2.74 N/19 mm in Comparative Example 9, 3.2 N/19 mm in Example 22, and 5 N/19 mm in Example 23.

In addition, in Comparative Examples 10 and 11 and Examples 24 and 25, the insulating tape was wound around a conductor having a conductor diameter x of 9.4 mm at an overlap length y of 3 mm, to form the insulated electric wires. The adhesive force c was 2.36 N/19 mm in Comparative Example 10, 2.74 N/19 mm in Comparative Example 11, 3.2 N/19 mm in Example 24, and 5 N/19 mm in Example 25.

In addition, in Comparative Examples 12 and 13 and Examples 26 and 27, the insulating tape was wound around a conductor having a conductor diameter x of 14.7 mm at an overlap length y of 3.5 mm, to form the insulated electric wires. The adhesive force c was 2.36 N/19 mm in Comparative Example 12, 2.74 N/19 mm in Comparative Example 13, 3.2 N/19 mm in Example 26, and 5 N/19 mm in Example 27.

The insulated electric wires in Examples 22 to 27 and Comparative Examples 8 to 13 formed as described above were held in a self-radially bent state for several seconds, and measurement was made as to whether the conductor was exposed. As a result, no exposure occurs in Examples 22 to 27, while exposure occurs in Comparative Examples 8 to 13.

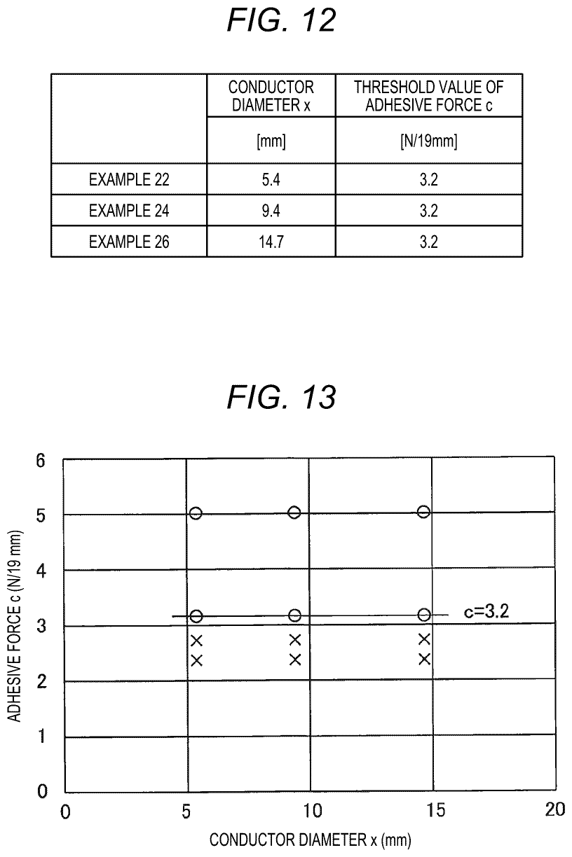

FIG. 12 is a table showing threshold values of the adhesive force c based on experiment results in Examples 22 to 27 and Comparative Examples 8 to 13. As shown in FIG. 11 and FIG. 12, in the case of a conductor diameter x of 5.4 mm, when the adhesive force c is 3.2 N/19 mm or more, which is equal to or greater than that in Example 22, the conductor exposure is prevented. In addition, in the case of a conductor diameter x of 9.4 mm, when the adhesive force c is 3.2 N/19 mm or more, which is equal to or greater than that in Example 24, the conductor exposure is prevented. In addition, in the case of a conductor diameter x of 14.7 mm, that is the adhesive force c is 3.2 N/19 mm or more, which is equal to or greater than that in Example 26, the conductor exposure is prevented.

FIG. 13 is a graph showing details of the experiment results and the threshold values in Examples 22 to 27 and Comparative Examples 8 to 13. As shown in FIG. 13, for all conductor diameters x of 5.4 mm, 9.4 mm, and 14.7 mm, the adhesive force c of the insulating tape needs to be 3.2 N/19 mm or more. Therefore, it is seen that in the case of winding the insulating tape having a width z of 19 mm at the overlap length y shown in FIG. 5, when the adhesive force c of the insulating tape is 3.2 N/19 mm or more, the conductor exposure during self-radial bending is prevented.

As shown in FIG. 6, it is clear that the greater the overlap length y, the more the conductor exposure is prevented. Therefore, when the adhesive force c of the insulating tape is ensured to be 3.2 N/19 mm, the conductor exposure during self-radial bending can be prevented even in an insulating tape having an overlap length y more than the threshold values shown in FIG. 5. In addition, as shown in FIG. 7, the smaller the width z of the insulating tape, the more the conductor exposure is prevented. Therefore, when the adhesive force c of the insulating tape is ensured to be 3.2 N/19 mm, the conductor exposure during self-radial bending can be prevented even in an insulating tape having a width z of 19 mm or less.

As seen in consideration of the above Examples 1 to 27 and Comparative Examples 1 to 13, when the insulating tape has an overlap length y of 1.5099 ln(x)−0.4959 mm or more, a width z of −0.3774x+24.547 mm or less, and an adhesive force c of 3.2 N/19 mm or more with respect to the back surface of the insulating tape, the conductor exposure during self-radial bending is prevented.

In this way, with the insulated electric wire 1 according to the present embodiment, since the adhesive force c of the insulating tape 20 is 3.2 N/19 mm or more with respect to the back surface of the insulating tape 20, the insulating tape 20 is unlikely to shift relatively during bending. In addition, since the overlap length y is 1.5099 ln(x)−0.4959 mm or more, even when there is a slight shift, the overlap length y is ensured, and the conductor exposure is prevented. When the width z of the insulating tape 20 is large, a large force is applied to one point on the overlap length y during bending, and the insulating tape 20 is likely to shift, but such a situation can be prevented since the width z of the insulating tape 20 is-0.3774x+24.547 mm or less. Therefore, it is possible to reduce a possibility of the exposure of the conductor 10 during bending.

In addition, since the width z of the insulating tape 20 is less than 3.2978x+2.282 mm, it is possible to prevent a situation where the width z of the insulating tape 20 is too large relative to the conductor diameter x, the insulating tape 20 wrinkles when spirally wound or the overlap length y gradually increases, making it difficult to wind the insulating tape 20 in a spiral shape.

In addition, with the method for manufacturing the insulated electric wire 1 according to the present embodiment, it is possible to provide the insulated electric wire 1 having a reduced possibility of exposure of the conductor 10 during bending.

Further, since electron beam crosslinking is carried out prior to winding the insulating tape 20, it is possible to easily irradiate the entire insulating tape 20 with the electron beam. That is, when the insulating tape 20 is irradiated with an electron beam after winding, one side of the insulating tape 20 is irradiated with an electron beam, and it is difficult to irradiate the other side (as an opposite side) across the conductor 10 with the electron beam, making it difficult to increase the heat resistance temperature on the other side. However, when the insulating tape 20 is irradiated before winding, the electron beam is not hindered by the conductor 10, and it is easier to irradiate the entire insulating tape 20 with the electron beam. Therefore, the heat resistance temperature can be easily increased appropriately.

Although the present disclosure is described above based on the embodiment, the present disclosure is not limited to the embodiment described above, a modification may be made without departing from the gist of the present disclosure, and the known or well-known technique may be combined.

For example, in the above, the conductor 10 is assumed to be a single wire, but the conductor 10 is not limited to this and may be a twisted wire in which a plurality of wires are twisted together.

In the above Examples and Comparative Examples, the experiments were carried out with the conductor diameter x being 5.4 mm or more. This is because when the conductor diameter x is less than 5.4 mm, extrusion coating is more efficient. One of reasons for forming the insulated electric wire 1 by winding the insulating tape 20 around the conductor 10 is to reduce the diameter of the insulated electric wire 1 itself. When the conductor diameter x is less than 5.4 mm, the insulated electric wire 1 can be made sufficiently thin even by extrusion coating. Further, in the above Examples and Comparative Examples, the experiments were carried out at 14.7 mm or less. This is because when the conductor diameter x is more than 14.7 mm, the self-radial bending is difficult while the insulating tape 20 is wound around the conductor.

The present application is based on a Japanese patent application (No. 2023-005646) filed on Jan. 18, 2023, the contents of which are incorporated herein by reference.

What is claimed is:

1. An insulated electric wire formed by spirally winding an insulating tape laminating an insulating layer and an adhesive layer onto a conductor such that the adhesive layer is disposed onto the conductor, wherein
when a conductor diameter is x mm, the insulating tape has an overlap length y of y≥1.5099 ln(x)−0.4959 mm, a width z of z≤−0.3774x+24.547 mm, and an adhesive force c of c≥3.2 N/19 mm with respect to a back surface of the insulating tape which is opposite to the adhesive layer, and
the width z is set to satisfy a relationship of z<(a circumferential length of the conductor)+ (a threshold value of the overlap length y)+1.

2. A method for manufacturing an insulated electric wire, comprising:
preparing a conductor having a conductor diameter of x mm;
preparing an insulating tape laminating an insulating layer and an adhesive layer, the insulating tape having a width z of z≤−0.3774x+24.547 mm and z<(a circumferential length of the conductor)+ (a threshold value of the overlap length y)+1, and the insulating tape having an adhesive force c of c≥3.2 N/19 mm with respect to a back surface of the insulating tape which is opposite to the adhesive layer; and
spirally winding the prepared insulating tape such that the adhesive layer is disposed onto the prepared conductor and an overlap length y is y≥1.5099 ln(x)−0.4959 mm.

3. The method for manufacturing the insulated electric wire according to claim 2, further comprising:
performing electron beam crosslinking on the prepared insulating tape to increase a heat resistance temperature, wherein
the winding of the prepared insulating tape includes spirally winding the insulating tape subjected to the electron beam crosslinking.
